(19) United States
(12) Patent Application Publication
(10) Pub. No.: US 2022/0138788 A1
(43) Pub. Date: May 5, 2022

(54) METHOD OF PROVIDING A VARIABLE PRICING MODEL

(71) Applicant: Drink Branders, LLC, Traverse City, MI (US)

(72) Inventors: Marcus Christian, Rockford, MI (US); Douglas Christian, Somerset, MI (US)

(21) Appl. No.: 17/514,703

(22) Filed: Oct. 29, 2021

Related U.S. Application Data
(60) Provisional application No. 63/107,225, filed on Oct. 29, 2020.

(51) Int. Cl. G06Q 30/02

(52) U.S. Cl. CPC G06Q 30/0206

(57) ABSTRACT

A method for determining a per unit price of a product based on an ordered quantity of the product is disclosed. The method includes receiving, via a user interface, the order quantity of the product from a user, and comparing, by a processor, the ordered quantity with a plurality of price break points, wherein each price break point corresponds to a price level for the product. The method also includes determining, by the processor, that the ordered quantity lies between two adjacent price break points, and calculating, by the processor, the per unit price corresponding to the ordered quantity by using a linear curve between the price levels corresponding to the identified price break points.

### CROSS REFERENCE TO RELATED APPLICATION

This application claims the benefit of U.S. Provisional Application 63/107,225, which was filed on Oct. 29, 2020, the disclosure of which is hereby incorporated by reference.

### BACKGROUND OF THE INVENTION

### 1. Field of the Invention

The present invention generally relates to a method and system for providing a variable unit price for a product. More particularly, the present invention pertains to a method for providing a variable unit price based on an ordered quantity of the product.

### 2. Description of the Prior Art

Sellers typically use discounted pricing models that offer decreased product pricing depending on the quantities of the products. These discounted pricing models are generally stepped pricing models in which the seller calculates decreasing per unit product prices based on several levels of the fixed minimum quantities. For example, the seller may offer a per unit price of $0.45 for a minimum quantity order of 12 units, while also offers a per unit price of $0.30 for a minimum quantity order of 24 units. The seller further discounts the per unit price to $0.28 for a minimum quantity order of 36 units. While this type of “quantity/price break” combination can be viewed as an incentive for encouraging the buyer to purchase more product, there is, however, a fundamental unfairness (certainly as viewed by the buyer) that is created in the use of such pricing structures.

To further elaborate upon the example above, a first buyer that orders 20 pens will pay the same per unit price as a second buyer that orders the minimum quantity of 12 pens. In this situation, the first buyer is actually better off ordering 24 pens than buying 20 pens since the first buyer will pay $9.00 for buying 20 pens, which is more than the cost of $7.20 for purchasing 24 pens. Therefore, discounted pricing based on a stepped pricing model is not fair to the buyer in some situations, and may not be attractive to the buyer in other situations.

### SUMMARY OF THE INVENTION

According to an aspect of the disclosure, a method for determining a per unit price of a product based on an ordered quantity of the product is disclosed. The method includes receiving, via a user interface, the order quantity of the product from a user, and comparing, by a processor, the ordered quantity with a plurality of price break points, wherein each price break point corresponds to a price level for the product. The method also includes determining, by the processor, that the ordered quantity lies between two adjacent price break points, and calculating, by the processor, the per unit price corresponding to the ordered quantity by using a linearly-decreasing per-unit price between the price levels corresponding to the identified price break points.

Optionally, the processor determines a price drop for each unit increment of quantity of the product between the two identified price break points by using the linear curve and determines the unit price corresponding to the ordered quantity by using the price drop.

Optionally the product includes two or more variable characteristics, and the variable characteristics can include one or more of the following: a color of the product, a color of a component of the product, or a size of the product.

According to another embodiment of the disclosure, there is provided a method for determining a variable per unit price of product based on an ordered quantity of the product, the method comprising: (a) receiving, via a user interface, the ordered quantity of the product from a user; (b) comparing, by a processor, the ordered quantity with a plurality of price break points, wherein each price break point corresponds to a price level for the product; (c) determining, by the processor, that the ordered quantity lies between an upper bounding quantity price break point and a lower bounding quantity price break point, the upper bounding quantity price break point having an upper bounding price point, and the lower bounding quantity price break point having a lower bounding price point; and (d) calculating, by the processor, the per unit price according to the following formula:

$${P}_{U} = P {P}_{L} - ( \frac{P {P}_{L} - P {P}_{H}}{{Q}_{H} - {Q}_{L}} ) * ( U - {Q}_{L} )$$

wherein U=the ordered quantity of the product from a user;

[symbol] _{H}=the upper bounding quantity price break point;

[symbol] _{L}=the lower bounding quantity price break point;

PP_{H}=the upper bounding price point;

PP_{L}=the lower bounding price point; and

P_{U}=the per unit price.

For a more complete understanding of the present invention, reference is made to the following detailed description and accompanying drawings. In the drawings, like reference characters refer to like parts throughout the views in which:

### BRIEF DESCRIPTION OF THE DRAWINGS

FIG. 1 is a graph depicting an exemplary stepped pricing model in the prior art;

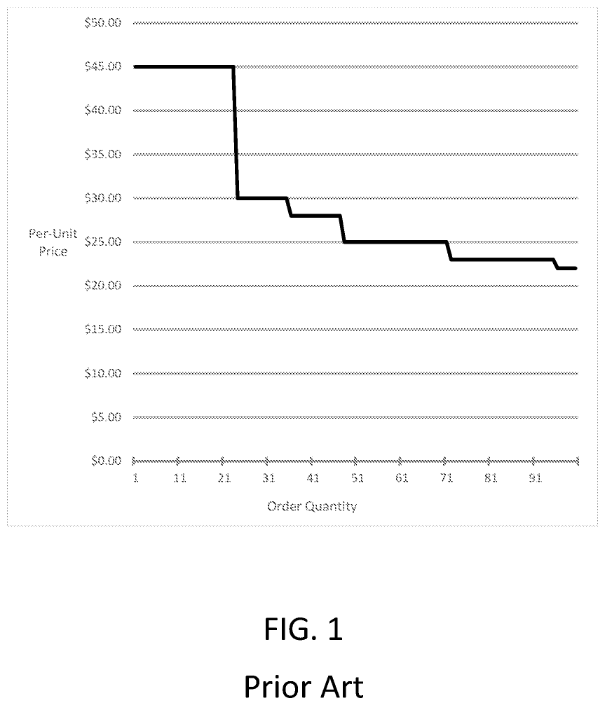

FIG. 2 is a graph depicting a variable pricing model according to an embodiment of the disclosure;

FIG. 3 illustrates a method for determining a unit price for a product based on an ordered quantity at an e-commerce system, in accordance with an embodiment of the disclosure; and

FIG. 4 illustrates a block diagram of the e-commerce system, in accordance with an embodiment of the disclosure.

### DETAILED DESCRIPTION OF A PREFERRED EMBODIMENT

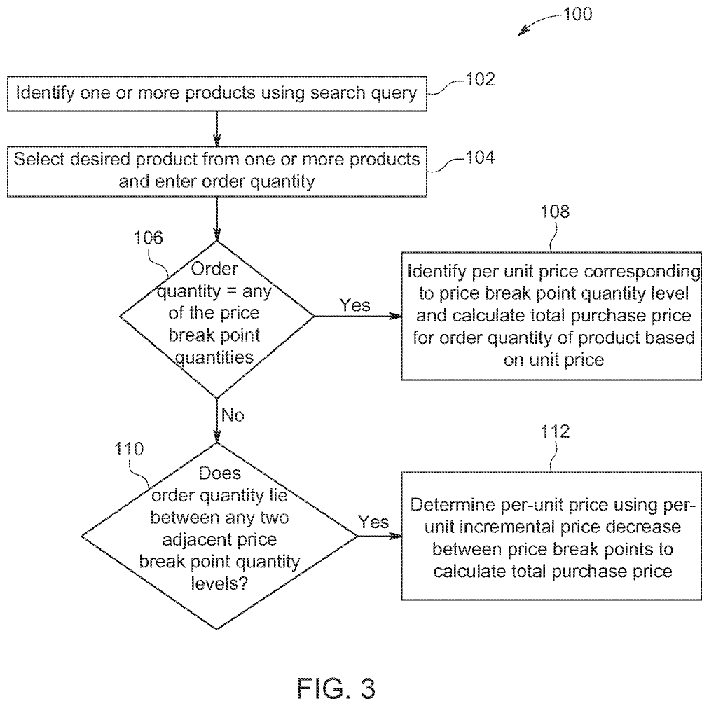

FIG. 3 is a flow diagram of a method 100 for providing a variable price for per unit of a product based on an ordered quantity of the product. The method 100 includes a step 102 in which a user inputs a search query into a user interface 202 of the e-commerce system 200 to identify one or more products available at the e-commerce system 200. The user may access the user interface 202 via a user device, such as, a mobile phone, a personal computer, etc. In an embodiment, the e-commerce system 200 may include a database 204 having a list of a plurality of products available for purchase by the user. In an embodiment, the e-commerce system 200 enables selection of the product from the plurality of products available in the database 204. In such a case, a processor 206 may run the search query into the database 204 to identify one or more products from the plurality of products, and displays the one or more products to the user via the user interface 202.

Thereafter, at a step 104 of the method 100, the user selects the desired product, and loads the desired product into a basket or a cart of goods, or otherwise enters a purchase quantity. The basket is a virtual basket in which the one or more products selected by the user are stored. After loading the basket with one or more desired items, the user may access the basket to view and analyze or review the desired product stored into the basket. Further, the basket enables the user to change the quantity of the product that the user wishes to purchase. Moreover, the basket may display various levels of prices per unit quantity and the number of units corresponding to each price level, or price break point, for the product inside the basket. For example, exemplary various levels of the per unit prices and price break points are shown in the following Table 1. In an embodiment, the price levels and corresponding order quantities may be displayed to the user before moving the desired product into the basket.

TABLE 1

| Ordered Quantity | Per-Unit Price |
|---|---|
| Up to 12 units | $45.00 |
| 24 | $30.00 |
| 36 | $28.00 |
| 48 | $25.00 |
| 72 | $23.00 |
| 96 or more | $22.00 |

Upon receiving the quantity of the product that the user wishes to purchase (i.e. hereinafter referred to as ordered quantity), the processor 206, at step 106, may check if the ordered quantity is equal to any of the price break points corresponding to the price levels. Subsequently, at step 108, the processor 206 may identify the per unit price corresponding to the price break point if the order quantity of the product matches with one of the price break points, and accordingly calculates a total purchase price of the product based on the unit price. Using Table 1 as an example, if the quantity of the product ordered by the user is equal to 24, then the processor 206 identifies that the ordered quantity matches with a first price break point and uses the corresponding unit price, i.e. $30.00, to calculate the total price for the 24 items.

However, the method moves to a step 110 if the processor 206 at the step 106 determines that the ordered quantity lies between any of the price break points. At the step 110, the processor 206 may check if the ordered quantity lies between the minimum quantities of any two adjacent price levels. The method 100 moves to a step 112 if the ordered quantity lies between the price break points corresponding to the two adjacent price levels. For example, if the ordered quantity is 17 units of the product, then the processor 206 identifies that the ordered quantity lies between two adjacent minimum quantities levels (i.e., 12 units and 24 units). Once the two price break points have been identified, then the processor 206, at step 112, determines the unit price to be used for calculating the total price of the order.

The processor 206 accomplishes this by first determining the price level for each of the identified price break points. For example, the processor 206 may determine a first price level as $45.00 for a quantity level of 12 units or less, and a second unit price level as $30.00 for the second price break point of 24. Subsequently, the processor 206 calculates the per unit price according to the following formula:

$${P}_{U} = P {P}_{L} - ( \frac{P {P}_{L} - P {P}_{H}}{{Q}_{H} - {Q}_{L}} ) * ( U - {Q}_{L} )$$

Wherein,

P_{U}=the calculated price per unit for the number of units ordered

U=the number of units ordered

Q_{L}=the lower bounding quantity price break point

Q_{H}=the upper bounding quantity price break point

PP_{L}=the price point at the lower bounding quantity price break point

PP_{H}=the price point at the upper bounding quantity price break point

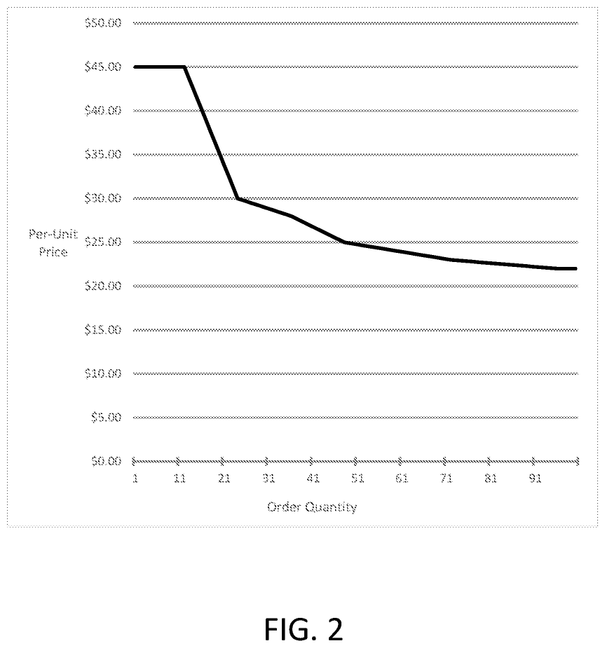

As shown in FIG. 2, the plotted series of order volume and the resulting per unit prices result in a price curve that consists of linear segments between each price break point, referred to as a linear curve). This price curve and/or its data points may be stored into a variable pricing module 208, or alternatively the preceding formula can be stored into a variable pricing module 208 and used to calculate the per unit price “on demand” based upon user input. The linear curve may depict a relationship between the unit price and the quantity of product ordered between the first price level and the second price level with the Y-axis depicting the unit price, while the X-axis depicts the quantity of the product ordered. In an embodiment, the processor 206 may calculate a price drop for each unit increment between any two price levels based on the difference of identified price break points, and then use the price drop for calculating the final unit price for the ordered quantity.

Referring back to the exemplary data found in Table 1, the processor 206 may determine that the price drop for each unit quantity increment between the first price level of 12 units and the second price level of 24 units is $1.25 since the price drops from $45.00/unit at 12 units to $30.00/unit at 24 units ($15.00 price decrease spread out over a 12 unit difference). Using the per-unit price drop of $1.25 for each unit quantity increment of the product between the price break points of 12 and 24 units, then the per-unit price can be determined. For example, the per-unit price for 18 units would be $37.50. Similarly, referring back to the formula herein above, providing values for the formula as follows: U=18, Q_{L}=12, Q_{H}=24, PP_{L}=45, and PP_{H}=30, results in the calculated price per unit (P_{U}) equaling $37.50. Therefore, in the instant example, the processor 206 would determine the unit price corresponding to the order quantity of 18 as $37.50 per unit, and accordingly determines the total price for the order quantity as $675.00. In this manner, the variable pricing model provides for adjusting the unit price of the product according to the order quantity and thereby provides the benefit of discounted pricing with unit increment of the order quantity. Accordingly, the discounted pricing based on the above describes variable pricing model provides incentive to the buyer for purchasing the increased quantity of item, while still providing a fair discounted price to the buyer.

In an embodiment, the variable pricing model may be applied based on the total quantity of a group of products that user wishes to purchase. The variable pricing module 208 may store a list of products that can be grouped together to avail the variable pricing discount. In an embodiment, the processor 206 may group the products based on one or more variable characteristics of the products, such as color of the products, the color of the different components of the products, sizes, etc. For example, the user may wish to the purchase 50 units of drinkware, each one including a bottle and a removable cap. The user is able to select from a variety of colors for the bottles and caps. For example, the user may select 15 red bottles, 30 blue bottles, and 5 yellow bottles, and then 15 yellow caps, 30 red caps, and 5 blue caps. In this example, as the bottles and caps only vary in colors and they form the components of the drinkware, the processor 206 may group the products bottle and the caps together and may categorize the items as the drinkware. Accordingly, the processor 206 determines the discounted unit price corresponding to the 50 complete drinkware, and calculates the total price of the 50 units of drinkware based on the discounted unit price for a purchase quantity of 50. In this manner, the system provides the benefit of a price discount for buying 50 complete drinkware units even though the user had mixed and matched the colors of both the bottles and the caps.

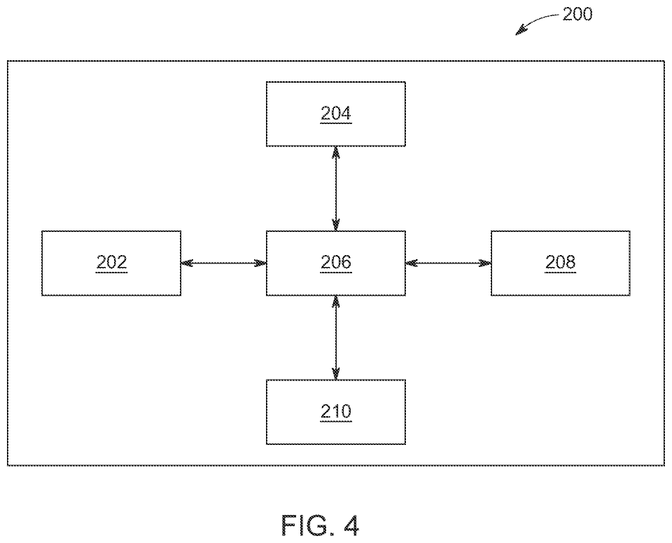

FIG. 4 is a block diagram depicting the exemplary e-commerce system 200. In an embodiment, the various sub-systems or the modules may be stored in a server and may communicate with a user device via a communication module 210. As shown, the e-commerce system 200 includes the user interface 202 that interacts with the user through the user device. In an embodiment, the user interface 202 is displayed on the user device when the user accesses the e-commerce system 200, such as by entering a website address or URL of the e-commerce system 200. The e-commerce system 200 further includes the database 204 for storing the list of products available for purchase. Further, the database 204 also stores one or more details, for example a name of the product, a price of the product, one or more specification of the products, etc. Further, the e-commerce system 200 includes the processor 206, the variable price module 208, and the communication module 210. The processor 206 may be in communication with each of the user interface 202, the database 204 and the variable price module 208 to exchange data or information and perform one or more action based on the data or information received. For example, the processor 206 may identify a list of products stored in the database 204 according to a search query of the user that was entered into the user interface 202. The processor 206 directs the user interface 202 to display the resulting list of products at the user device. The processor 206 may communicate with the user device via the communication module 210 to exchange information with the user device.

Furthermore, the variable price module 208 is configured to store the price break point for each price level for various products in the database 204, as well as the formula provided hereinabove to enable the processor 206 to calculate the specific per-unit price for any order quantity of any products stored in the database 204. Alternatively, the various price module 208 may store a model, equation, or a curve that enables the processor 206 to calculate the per unit price for the ordered quantity if the ordered quantity lies between price break points. Further, the various price module 208 may store a list of products that can be grouped together to facilitate a cumulative buying of the products by the user, while still allowing the user to avail the price discounts as per the variable pricing. In an embodiment, the variable price module may include information about one or more variable characteristics of the products for grouping the items in a group of products.

It should be understood that the foregoing description is only illustrative of the aspects of the disclosed embodiments. Various alternatives and modifications can be devised by those skilled in the art without departing from the aspects of the disclosed embodiments. Accordingly, the aspects of the disclosed embodiments are intended to embrace all such alternatives, modifications, and variances that fall within the scope of the appended claims. Further, the mere fact that different features are recited in mutually different dependent or independent claims does not indicate that a combination of these features cannot be advantageously used, such as a combination remaining within the scope of the aspects of the disclosed embodiments.

What is claimed is:

1. A method for determining a variable per unit price of product based on an ordered quantity of the product, the method comprising:
receiving, via a user interface, the ordered quantity of the product from a user;
comparing, by a processor, the ordered quantity with a plurality of price break points, wherein each price break point corresponds to a price level for the product;
determining, by the processor, that the ordered quantity lies between two adjacent price break points; and
calculating, by the processor, the per unit price corresponding to the ordered quantity by using a linear curve between the price levels corresponding to the identified price break points.

2. The method of claim 1, wherein the processor determines a price drop for each unit increment of quantity of the product between the two identified price break points by using the linear curve and determines the unit price corresponding to the ordered quantity by using the price drop.

3. The method of claim 1, wherein the product includes two or more variable characteristics.

4. The method of claim 3, wherein the variable characteristics include one or more of the following: a color of the product, a color of a component of the product, or a size of the product.

5. The method of claim 2, wherein the product includes two or more variable characteristics.

6. The method of claim 5, wherein the variable characteristics include one or more of the following: a color of the product, a color of a component of the product, or a size of the product.

7. A method for determining a variable per unit price of product based on an ordered quantity of the product, the method comprising:
receiving, via a user interface, the ordered quantity of the product from a user;
comparing, by a processor, the ordered quantity with a plurality of price break points, wherein each price break point corresponds to a price level for the product;
determining, by the processor, that the ordered quantity lies between an upper bounding quantity price break point and a lower bounding quantity price break point, the upper bounding quantity price break point having an upper bounding price point, and the lower bounding quantity price break point having a lower bounding price point; and
calculating, by the processor, the per unit price according to the following formula:
$${P}_{U} = P {P}_{L} - ( \frac{P {P}_{L} - P {P}_{H}}{{Q}_{H} - {Q}_{L}} ) * ( U - {Q}_{L} )$$
wherein U=the ordered quantity of the product from a user; [symbol]
_{H}=the upper bounding quantity price break point; [symbol]
_{L}=the lower bounding quantity price break point;
PP_{H}=the upper bounding price point;
PP_{L}=the lower bounding price point; and
P_{U}=the per unit price.

8. The method of claim 7, wherein the product includes two or more variable characteristics.

9. The method of claim 8, wherein the variable characteristics include one or more of the following: a color of the product, a color of a component of the product, or a size of the product.
